(19) United States
(12) Patent Application Publication
(10) Pub. No.: US 2006/0248756 A1
(43) Pub. Date: Nov. 9, 2006

(54) Vivid three-dimensional illustrated card and method to fabricate the vivid three-dimensional illustrated card

(76) Inventor: Teng-Kuei Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/119,777

(22) Filed: May 3, 2005

(51) Int. Cl. G09F 1/00

(52) U.S. Cl. 40/124.01

(57) ABSTRACT

A vivid three-dimensional (3D) illustrated card has a base, a printed ink layer and multiple 3D decorations. The printed ink layer is applied to the base and has at least one colored pattern and character. The 3D decorations are attached to the front surface of the printed ink layer on the base and correspond respectively to parts of the at least one pattern and character. Each 3D decoration has a U-shaped wire and a decorative element. The decorative element is mounted on the U-shaped wire and is colored to match the color of the corresponding part of at least one pattern and character on the printed ink layer. The illustrated card with the 3D decorations looks vivid and attractive. Furthermore, the 3D decorations are attached tightly to the printed ink layer on the base by using the tool set so the 3D illustrated card is more durable.

### BACKGROUND OF THE INVENTION

1. Field of the Invention

The present invention relates to an illustrated card, and more particularly to a vivid three-dimensional (3D) illustrated card having decorations and a method to fabricate the vivid 3D illustrated card.

2. Description of Related Art

Illustrated cards such as greeting cards and Christmas cards are popular.

A conventional illustrated card comprises a piece of cardboard or thin fiberboard and a printed ink layer applied to part of the cardboard or fiberboard. The printed ink layer may be patterns, characters, words, scenes or the like as a decoration to attract and please people.

Another conventional illustrated card incorporates a bas-relief feature by attaching decorative cutouts on stand-off strips to the cardboard or fiberboard with adhesive to make the illustrated card more vivid. However, adhesive can make the illustrated card unsightly. Furthermore, the protruding decorations easily fall off when struck by an inadvertent small force and tend to be somewhat delicate.

To overcome the shortcomings, the present invention provides a vivid three-dimensional (3D) illustrated card and a method to fabricate the vivid 3D illustrated card to mitigate or obviate the aforementioned problems.

### SUMMARY OF THE INVENTION

The main objective of the invention is to provide a three-dimensional (3D) illustrated card that is vivid and attractive.

A vivid 3D illustrated card has a base, a printed ink layer and multiple three-dimensional (3D) decorations.

The printed ink layer is applied to the base and has at least one colored pattern and character.

The 3D decorations are attached to the front surface of the printed ink layer on the base and correspond respectively to parts of the at least one colored pattern and character. Each 3D decoration has a U-shaped wire and a decorative element. The decorative element is mounted on the U-shaped wire and is colored to match the color of the corresponding part of at least one pattern and character of the printed ink layer.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a vivid three-dimensional (3D) illustrated card;

FIG. 2 is a bottom view in partial section of the vivid 3D illustrated card in FIG. 1;

FIG. 3 is a bottom view of a first embodiment of a decoration for the vivid 3D illustrated card in FIG. 1;

FIG. 4 is a bottom view of a second embodiment of a decoration for the vivid 3D illustrated card in FIG. 1;

FIG. 5 is a front plan view of a third embodiment of a decoration for the vivid 3D illustrated card in FIG. 1;

FIG. 6 is a perspective view of a die mold of a vivid 3D illustrated card tool set used in a method to fabricate the vivid 3D illustrated card in FIG. 1; FIG. 7 is a top view of the die mold in FIG. 6;

FIG. 8 is a perspective view of a hand-held tool of the vivid 3D illustrated card tool set used in the method to fabricate the vivid 3D illustrated card in FIG. 1;

FIG. 9 is a flow diagram of a method to fabricate the 3D illustrated card in accordance with the present invention;

FIG. 10A is an operational front view of a semi-finished 3D decoration aligned with the die mold in FIG. 7;

FIG. 10B is an operational front view of the hand-held tool in FIG. 8 aligned with the semi-finished 3D decoration above the die mold in FIG. 10A;

FIG. 10C is an operational front view in partial section of the hand-held tool pressed into the die mold and bending the 3D decoration in FIG. 10B;

FIG. 10D is an operational perspective view of the hand-held tool in FIG. 5 holding a finished 3D decoration; and

FIG. 10E is an operational perspective view of the 3D decoration on the hand-held tool in FIG. 10D being attached to the printed ink layer on the base of an illustrated card.

### DETAILED DESCRIPTION OF PREFERRED EMBODIMENT

A vivid three-dimensional (3D) illustrated card in accordance with the present invention and a method to fabricate the vivid 3D illustrated card in accordance with the present invention overcome or mitigate the shortcomings of conventional illustrated cards.

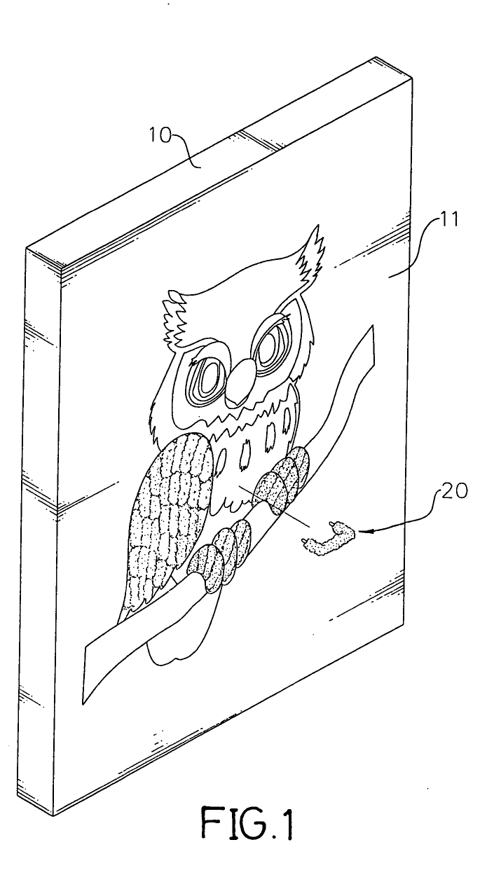

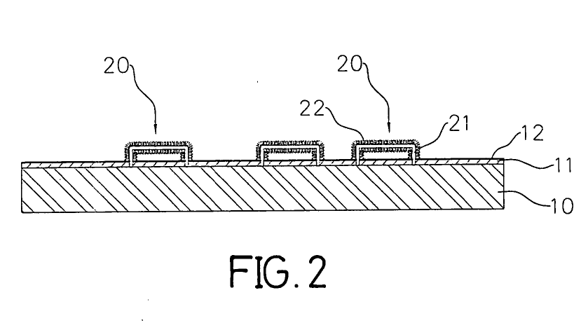

With reference to FIGS. 1 and 2, a vivid three-dimensional (3D) illustrated card in accordance with the present invention comprises a base (10), a printed ink layer (11) and multiple 3D decorations (20).

The base (10) is a panel of fiberboard, resilient polystyrene plastic or the like and has a front surface.

The printed ink layer (11) is applied to the front surface of the base (10) and has at least one colored pattern and character and a transparent protective layer (111). The pattern of the printed ink layer (11) can be an animal such as an owl or an attractive scene. The transparent protective layer (111) is attached to the front surface of the printed ink layer (11). When a needle (not shown) penetrates the transparent protective layer (111), the printed ink layer (11) and the base (10) to define a hole, the transparent protective layer (111) prevents the hole from extending excessively.

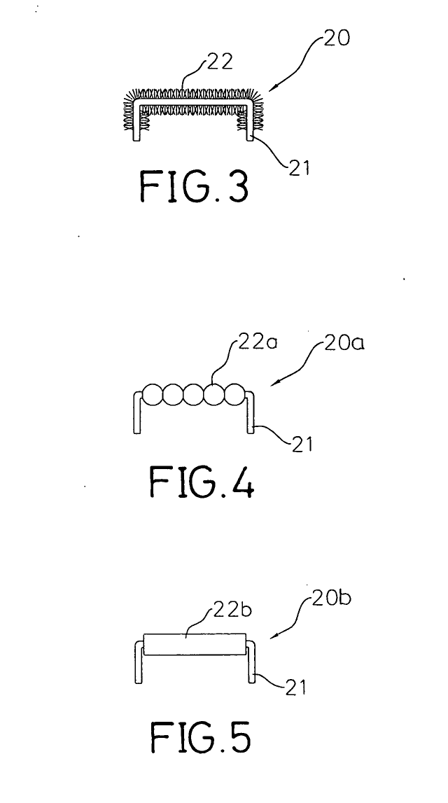

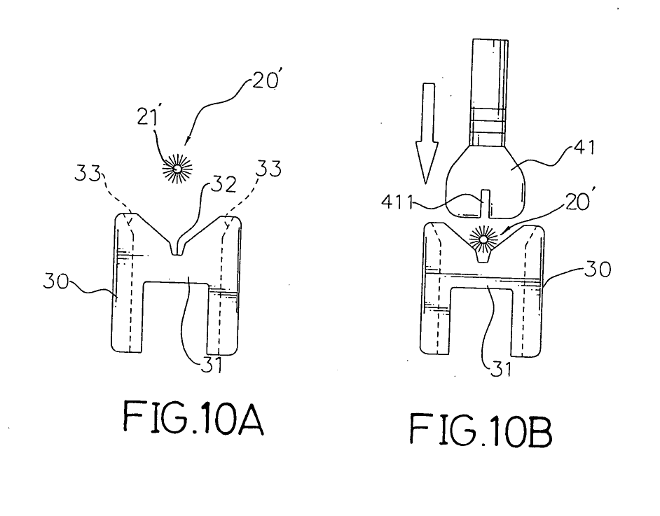

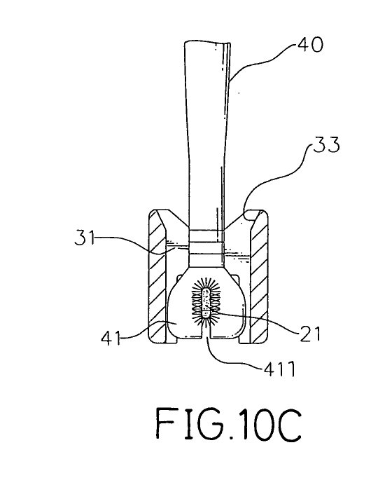

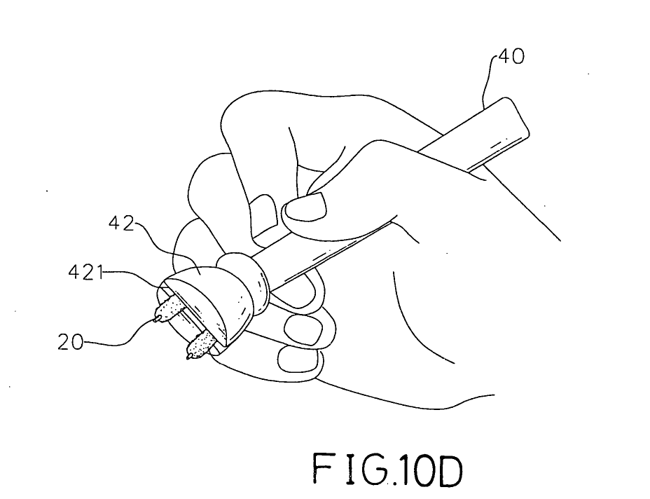

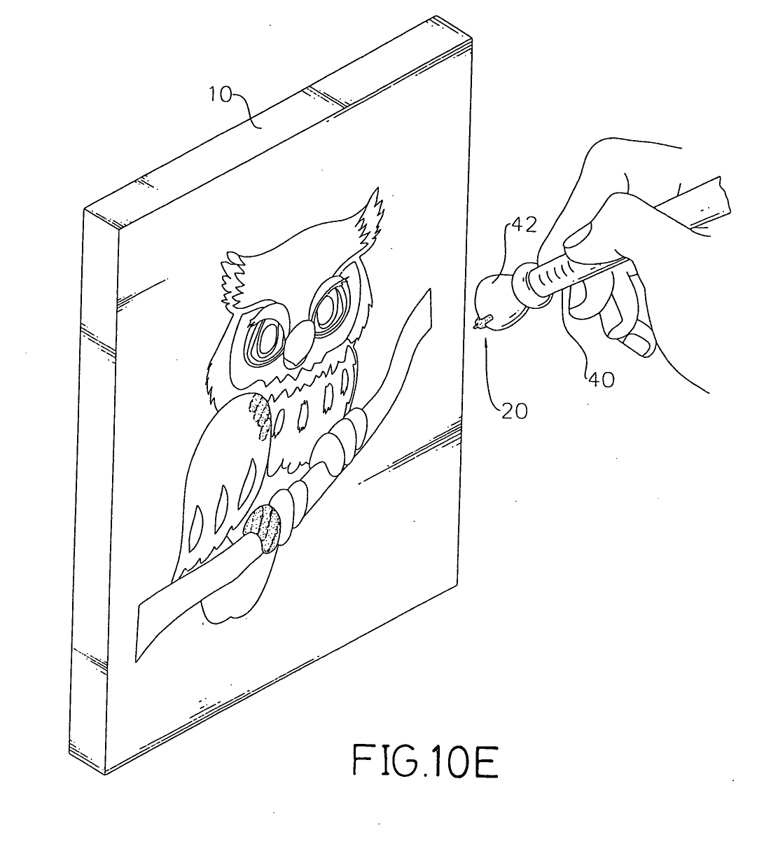

The 3D decorations (20) are attached to the front surface of the printed ink layer (11) on the base (10) and correspond respectively to parts of the at least one pattern and character. Each 3D decoration (20) has a U-shaped wire (21) and a decorative element. The U-shaped wire (21) is made of pliable material, is attached to the front surface of the printed ink layer (11) on the base (10) and has a straight section and two bent end sections. The bent end sections of the U-shaped wire (21) are perpendicular to the straight section and extend through the printed ink layer (11) into the base (10). The decorative element is mounted on the U-shaped wire (21) and is colored to match the color of the corresponding part of the pattern and character on the printed ink layer (11). With further reference to FIG. 3, a first embodiment of the decoration (20) has the decorative element implemented with colored fluff (22) mounted on the wire (21). With reference to FIG. 4, a second embodiment of the decoration (20a) has the decorative element implemented with multiple colored beads (22a) mounted on the wire (21). With reference to FIG. 5, a third embodiment of the decoration (20b) has the decorative element implemented with a colored tube (22b) mounted on the wire (21). With reference to FIG. 10A, the 3D decoration (20) is made by bending a straight wire (21′) of a semi-finished 3D decoration (20′) into the u-shaped wire (21).

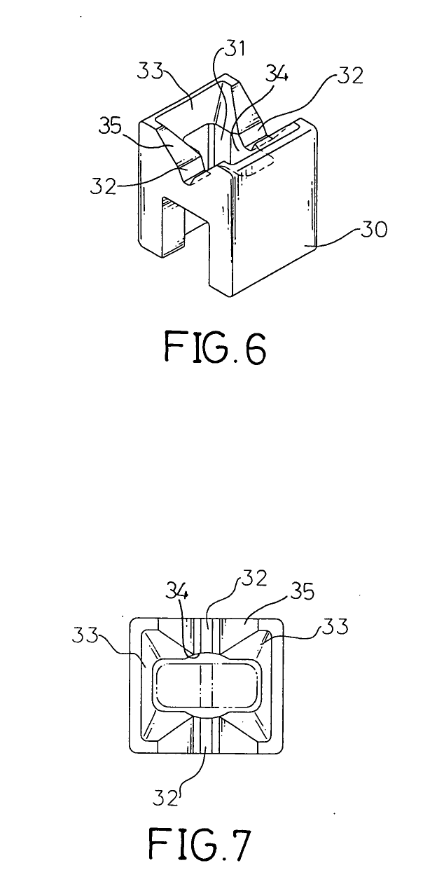

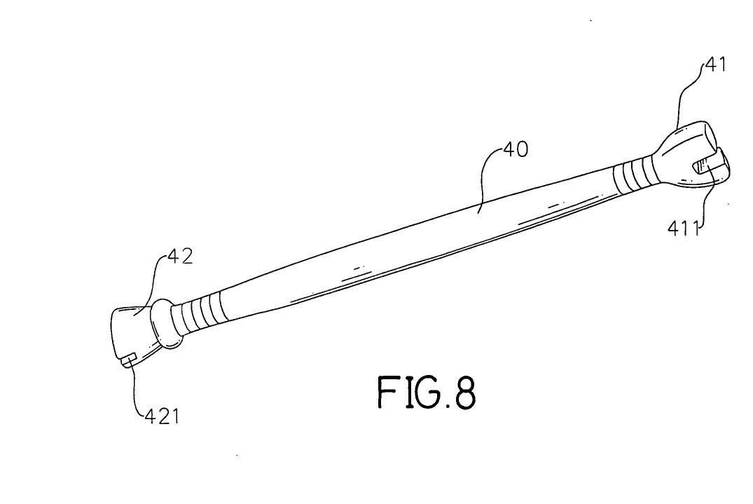

With reference to FIGS. 6 and 8, the method to fabricate the vivid 3D illustrated card is implemented with a vivid 3D illustrated card tool set comprising a die mold (30) and a hand-held tool (40).

With further reference to FIG. 7, the die mold (30) of the vivid 3D illustrated card tool set has an open top, an open bottom, a front wall, a rear wall, two opposite sidewalls, a through hole (31), two notches (32), two semi-finished decoration wire guides (35) and two decoration recesses (34). The open top has a top edge. The through hole (31) is defined vertically through the die mold (30) and communicates with the open top and the open bottom. The notches (32) are defined in the top edge respectively in the front wall and the rear wall, are aligned with each other and correspond to the semi-finished decoration (20′) to maintain the alignment of the semi-finished decoration (20′) until the decoration (20) is bent. The semi-finished decoration wire guides (35) guide a semi-finished decoration (20′) into the notches (32), are defined in the top edge of the open top respectively at the front and rear walls, are inclined inward from top to bottom and terminate respectively at the notches (32). The decoration recesses (34) allow a semi-finished decoration (20′) to bend without binding in the die mold (30), are defined respectively inside the front wall and the rear wall in the through hole (31) and face each other.

The hand-held tool (40) of the vivid 3D illustrated card tool set has two ends, a bending die (41) and a clamp (42). The bending die (41) is formed on one end of the hand-held tool (40), corresponds to and passes through the through hole (31) in the die mold (30) and has an alignment notch (411). The alignment notch (411) is defined transversely in the bending die (41) to hold a semi-finished decoration (20′) until the finished product (20) is bent in the die mold (30). The clamp (42) is formed on the other end of the hand-held tool (40) and has a clamping notch (421).

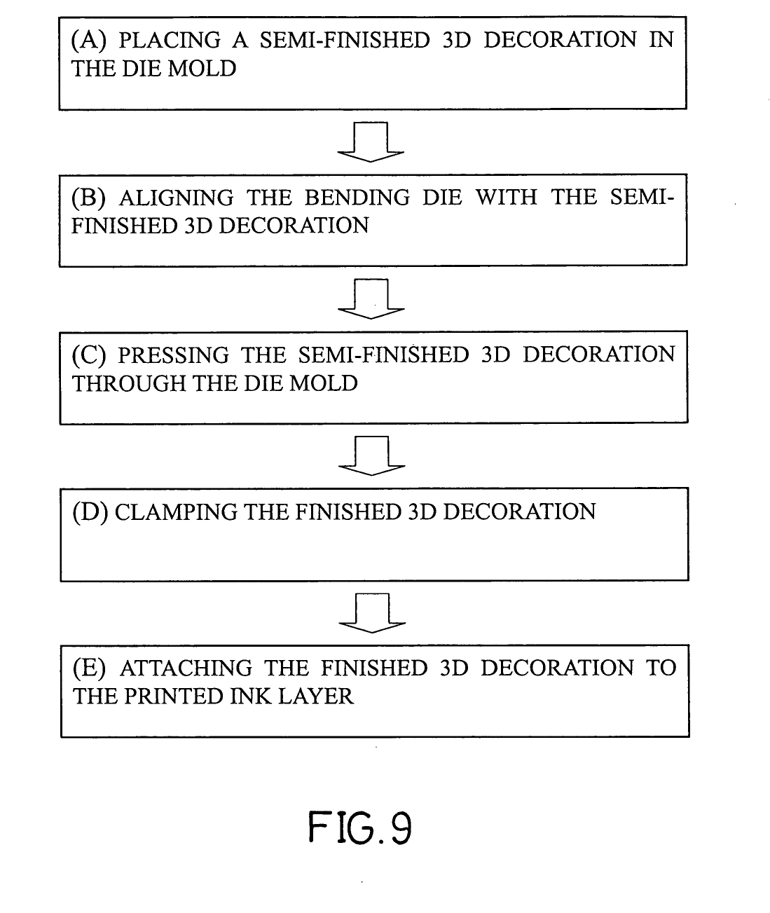

With further reference to FIG. 9, the method comprises steps of placing a semi-rigid 3D decoration (20′) in the die mold (30) (A), aligning the bending die (41) with the semi-finished 3D decoration (20′) (B), pressing the semi-finished 3D decoration (20′) through the die mold (C), clamping the finished 3D decoration (20) (D) and attaching the finished 3D decoration (20) to the printed ink layer (11) (E).

With further reference to FIG. 10A, the step of placing a semi-rigid 3D decoration (20′) in the die mold (30) (A) comprises placing a semi-finished 3D decoration (20′) with a straight wire (21′) in the notches (32) in the die mold (30).

With further reference to FIG. 10B, the step of aligning the bending die (41) with the semi-finished 3D decoration (20′) (B) comprises aligning the bending die (41) with semi-finished 3D decoration (20′) and the through hole (31) in the die mold (30).

With reference to FIG. 10C, the step of pressing the semi-finished 3D decoration (20′) through the die mold (C) comprises pressing the semi-finished 3D decoration (20′) with the bending die (41) of the hand-held tool (40) through the through hole (31) in the die mold (30) from the open top to the open bottom to bend the end sections of the straight wire (21′) perpendicular and finish the 3D decoration (20).

With reference to FIG. 10D, the step of clamping the finished 3D decoration (20) (D) comprises clamping the finished 3D decoration (20) with the clamp (42) on the hand-held tool (40).

With reference to FIG. 10E, the step of attaching the finished 3D decoration (20) to the printed ink layer (11) (E) comprises attaching the clamped finished 3D decoration (20) to an appropriate part of the printed ink layer (11) on the base (10) by pressing the clamp (42) of the hand-held tool (40) onto the printed ink layer (11) to staple the finished 3D decoration (20) through the printed ink layer (11) into the base (10). The colored decorative elements of the 3D decorations (20) correspond to the-pattern or characters on the printed ink layer (11) and make the pattern or characters look more vivid.

The illustrated card with the 3D decorations (20) looks vivid and attractive. Furthermore, the 3D decorations (20) are attached tightly to the printed ink layer (11) on the base (10) by using the tool set so the vivid 3D illustrated card is more durable.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A vivid three-dimensional (3D) illustrated card comprising
a base and having a front surface;
a printed ink layer applied to the front surface of the base and having at least one colored pattern and character; and
multiple 3D decorations attached to the front surface of the printed ink layer on the base and corresponding respectively to parts the at least one pattern and the character, and each 3D decoration having
a U-shaped wire, attached to the front surface of the printed ink layer on the base; and
a decorative element mounted to the U-shaped wire and colored.

2. The illustrated card as claimed in claim 1, wherein the printed ink layer further has a transparent protective layer attached to the front surface of the printed ink layer to prevent a hole defined by penetrating a needle through the printed ink layer into the base from penetrating excessively.

3. The illustrated card as claimed in claim 1, wherein the decorative element of each 3D decoration is implemented with colored fluff mounted on the wire.

4. The illustrated card as claimed in claim 1, wherein the decorative element of each 3D decoration is implemented with multiple colored beads mounted around the wire.

5. The illustrated card as claimed in claim 1, wherein the decorative element of each 3D decoration is implemented with a colored tube mounted around the wire.

6. The illustrated card as claimed in claim 1, wherein the base is made of resilient polystyrene plastic.

7. The illustrated card as claimed in claim 1, wherein the base is made of fiberboard.

8. The illustrated card as claimed in claim 1, wherein the U-shaped wire is made of pliable material.

9. The illustrated card as claimed in claim 1, wherein the decorative element is colored to match the color of the corresponding part of at least one pattern and character on the printed ink layer.

10. A method to fabricate a vivid three-dimensional (3D) illustrated card comprising a base, a printed ink layer applied to the base and multiple 3D decorations attached to the base and fabricated from semi-finished 3D decorations by using a tool set comprising a die mold having an open top having a top edge, an open bottom, a through hole defined vertically through the die mold, and two notches defined in the top edge and a hand-held tool having two ends, a bending die formed on one end and a clamp form on the other end, and each 3D decoration having a U-shaped wire and a decorative element, the method comprising steps of:
placing a semi-finished 3D decoration with a straight wire in the notches in the die mold;
aligning the bending die on the hand-held tool with the semi-finished 3D decoration and the through hole in the die mold;
pressing the semi-finished 3D decoration with the bending die of the hand-held tool through the through hole in the die mold from the open top to the open bottom to bend the end sections of the straight wire perpendicular and finish the 3D decoration;
clamping the finished 3D decoration with the clamp on the hand-held tool; and
attaching the clamped finished 3D decoration to an appropriate part of the printed ink layer on the base.

11. A method to fabricate a vivid three-dimensional (3D) illustrated card as claimed in claim 10, wherein attaching the clamped finished 3D decoration to an appropriate part of the printed ink layer on the base is implemented by pressing the clamp of the hand-held tool onto the printed ink layer to staple the finished 3D decoration through the printed ink layer into the base.
